(19) United States
(12) Patent Application Publication
(10) Pub. No.: US 2009/0255153 A1
(43) Pub. Date: Oct. 15, 2009

(54) GROUP CALENDAR INTERFACE

(75) Inventors: Yasuhiko Mori, Kawasaki-shi (JP); Yusuke Bou, Tokyo (JP); Yoshiaki Hara, Tokyo (JP); Yukitoshi Kawabata, Tokyo (JP); Masafumi Shibata, Yokohama-shi (JP)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/103,700

(22) Filed: Apr. 15, 2008

(51) Int. Cl. G09D 3/00

(52) U.S. Cl. 40/107

(57) ABSTRACT

Technologies are described herein for providing an improved group calendar. Information is received from a central server. A group is generated based on the information. The group is provided in the group calendar interface.

### BACKGROUND

Calendar software applications have become a common management tool in many office environments. Conventional calendar software applications allow users to create one or more calendars for a variety of purposes. In one example, a user may create multiple calendars for personal and/or business use. In another example, a user may create individual calendars corresponding to different projects in a company. Once a calendar has been created, a user may create and store calendar items in the calendar to keep track of an event, such as a meeting, an appointment, and the like. A calendar item may include data describing the event, data identifying a time of the event, data specifying a location of the event, and other data related to the event.

Calendar software applications may be standalone software applications or integrated within other applications or software application suites. Calendar software applications may also link to other software applications that are adapted to integrate calendars and calendar items. Examples of calendar software applications include, but are not limited to, OUTLOOK, ENTOURAGE, and WINDOWS CALENDAR from MICROSOFT CORPORATION, ICAL from APPLE INC, and EVOLUTION from NOVELL INC.

Traditionally, calendar software applications have mimicked personal calendars and diaries, and thus, have included features primarily optimized for single users. In contrast, office environments often organize group events (e.g., group projects, brainstorming meetings, etc.) involving multiple users. To this end, the ability to view calendars for multiple users may be a useful tool for scheduling and organizing collaborative events. As such, software developers have implemented group calendar features into recent versions of many calendar software applications. These group calendar features have a number of drawbacks, however.

One group calendar feature provided by some calendar software applications is a multiple calendar display, which provides the ability to display multiple calendars at one time. In this way, a user can simultaneously view calendars associated with two or more members of a group. In the multiple calendar display, each calendar maintains its own interface, instead of being combined in a single interface. For example, multiple calendars may be displayed side-by-side in a tiled configuration. One drawback with this approach is that only a limited number of calendars can be displayed at a given time, depending on the size of the display. As more calendars are simultaneously displayed, the size of each of the calendars decreases. At some point, each of the calendars will become too small to be viewed and understood. Another drawback is that simultaneously displaying individual calendars may not allow users to visually compare schedules between multiple users in an optimal manner.

Another group calendar feature provided by some calendar software applications is a multiple user display. In contrast to the multiple calendar display, which simultaneously displays multiple calendars in separate interfaces, the multiple user display provides information associated with multiple calendars on a single interface. For example, multiple calendars may be displayed on a two-dimensional grid containing a number of calendar items. Each calendar item corresponds to a first axis, which represents a member of the group to which the calendar item belongs, and a second axis, which represents a time frame in which the calendar item is scheduled.

By displaying the information from multiple calendars on a single interface, the multiple user display provides some limited ability for users to visually compare schedules between multiple users. However, conventional calendar software applications may shift responsibility to each user in a group to manually create groups in the multiple user display. Also, if membership of the group changes, each user may be responsible for manually adding new group members and deleting former group members.

It is with respect to these considerations and others that the disclosure made herein is presented.

### SUMMARY

Technologies are described herein for providing an improved group calendar. In particular, through the utilization of the technologies and concepts presented herein, a group calendar software application that is adapted to provide a group calendar interface is disclosed. When a user accesses the group calendar interface, the group calendar software application generates and displays one or more groups relevant to user. In one embodiment, the group calendar software application generates the groups based on information provided by a central server, such as an email server or other suitable server. When the information on the central server changes, the group calendar software application may adjust the groups displayed to the user. In this way, the user is not responsible for manually updating the group calendar software application when group membership changes.

The group calendar interface displays information from multiple calendars in a single interface. In one embodiment, the group calendar interface is presented in a two-dimensional grid, which includes a plurality of calendar items. Each calendar item corresponds to a group member on a first axis and a time frame on a second axis. The group calendar interface may further provide a group availability indicator and a group scheduling function. The group availability indictor is a suitable graphical element that indicates whether every member of a group is available at a given time frame. The group scheduling function is a function provided by the group calendar interface that enables the user to schedule a calendar item for multiple group members at one time. In this way, the user is not responsible for individually scheduling the same calendar item for every group member.

According to one aspect presented herein, a computer program is provided for providing a group calendar interface. The computer program receives information from a central server. One or more groups may be generated based on the information. Upon generating the groups, the computer program provides the groups in the group calendar interface. It should be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a screen display diagram showing an illustrative screenshot of a multiple calendar display;

FIG. 2 is a screen display diagram showing an illustrative screenshot of a multiple user display;

FIG. 3 is a network architecture diagram showing aspects of a network architecture capable of providing an improved group calendar, in accordance with one embodiment;

FIG. 4 is a screen display diagram showing an illustrative screenshot of an implementation of a group calendar interface, in accordance with one embodiment;

FIG. 5 is a screen display diagram showing an illustrative screenshot of another implementation of the group calendar interface, in accordance with one embodiment;

FIG. 6 is a flow diagram showing an illustrative process for providing the group calendar interface, in accordance with one embodiment; and

FIG. 7 is a computer architecture diagram showing aspects of an illustrative computer hardware architecture for a computing system capable of implementing aspects of the embodiments presented herein.

### DETAILED DESCRIPTION

The following detailed description is directed to technologies for providing an improved group calendar. Through the utilization of the technologies and concepts presented herein, a group calendar software application that is adapted to provide a group calendar interface is provided. When a user accesses the group calendar interface, the group calendar software application generates and displays one or more groups relevant to user. In one embodiment, the group calendar software application generates the groups based on information provided by a central server, such as an email server or other suitable server. When the information on the central server changes, the group calendar software application may adjust the groups displayed to the user. In this way, the user is not responsible for manually updating the group calendar software application when group membership changes.

The group calendar interface displays information from multiple calendars in a single interface. In one embodiment, the group calendar interface is presented in a two-dimensional grid, which includes a plurality of calendar items. Each calendar item corresponds to a group member on a first axis and a time frame on a second axis. The group calendar interface may further provide a group availability indicator and a group scheduling function. The group availability indictor is a suitable graphical element that indicates whether every member of a group is available at a given time frame. The group scheduling function is a function provided by the group calendar interface that enables the user to schedule a calendar item for multiple group members at one time. In this way, the user is not responsible for individually scheduling the same calendar item for every group member.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

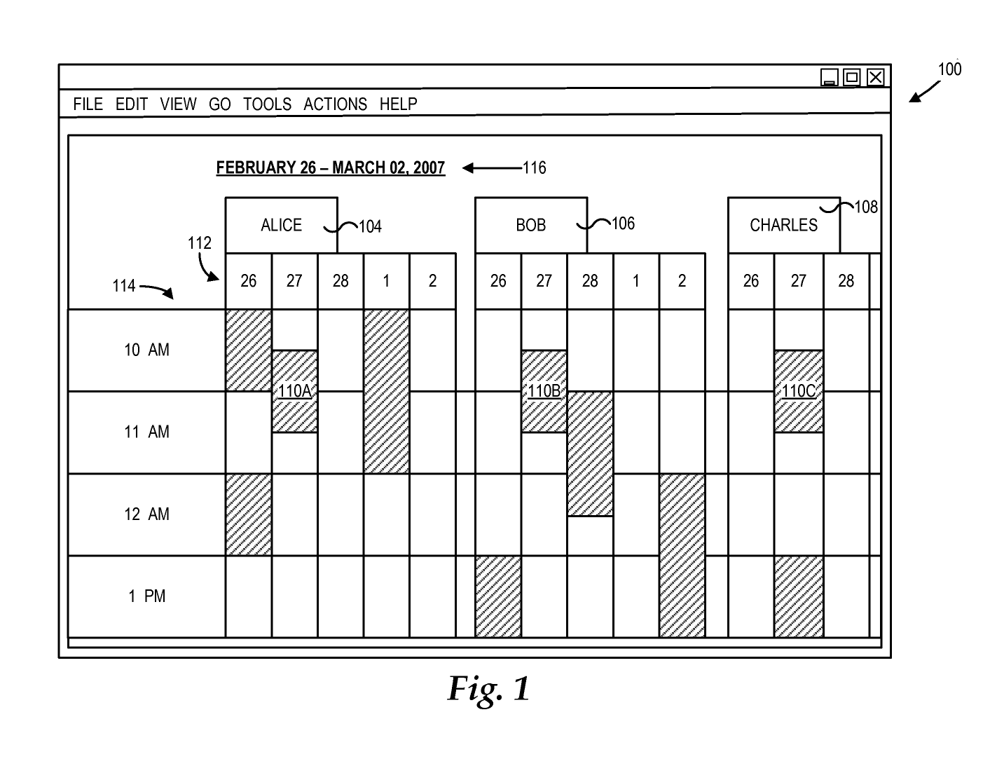

In the following detailed description, references are made to the accompanying drawings that form a part hereof, and which are shown by way of illustration specific embodiments or examples. Referring now to the drawings, in which like numerals represent like elements through the several figures, FIG. 1 will be described, which shows aspects of a conventional multiple calendar display as previously described. In particular, FIG. 1 shows an illustrative screenshot 100 of an exemplary implementation of a multiple calendar display. The screenshot 100 includes a first calendar 104, a second calendar 106, and a third calendar 108. The first calendar 104 is associated with a first user named “Alice”. The second calendar 106 is associated with a second user named “Bob”. The third calendar 108 is associated with a third user named “Charles”.

As illustrated in FIG. 1, each of the calendars 104-108 is displayed in a separate interface. That is, the first calendar 104, the second calendar 106, and the third calendar 108 are displayed as separate calendars. Each of the calendars 104-108 provides a grid containing a plurality of calendar items, such as a first item 110A, a second item 110B, and a third item 110C. The calendar items may correspond to a scheduled meeting, appointment, or other suitable event. In one embodiment, the calendar items are indicated by shading, as illustrated in FIG. 1. In other embodiments, the calendar items may be indicated by other suitable graphical representation. Although not so illustrated in FIG. 1, each of the calendar items may also include text describing the calendar item.

Each of the plurality of calendar items corresponds to a day along a horizontal axis 112 and a time frame along a vertical axis 114. The horizontal axis 112 lists five days between Feb. 26, 2007 and Mar. 2, 2007 as indicated at 116. The vertical axis 114 lists a time span between 10 AM and 1 PM from which a time frame for each calendar item may be selected.

Upon analyzing the multiple calendar display as illustrated in the screenshot 100, it becomes clear that as the number of calendars simultaneously displayed increases, the width of each of the calendars as well as the width of each of the calendar items also decreases. As the width of the each of the plurality of calendar items decreases, the amount of substantive information that can be displayed in the calendar item decreases. As such, the multiple calendar display becomes ineffective when an increased number of calendars are simultaneously displayed.

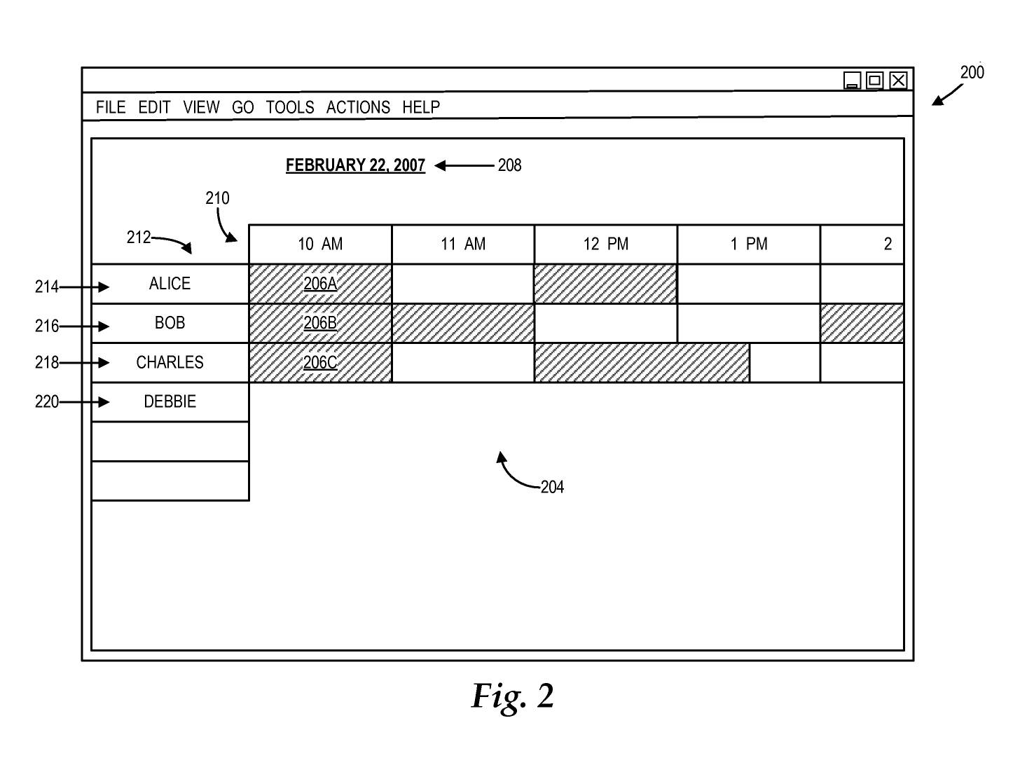

As an alternative to the multiple calendar display of FIG. 1, aspects of a conventional multiple user display, as previously described, are illustrated in FIG. 2. In particular, FIG. 2 shows an illustrative screenshot 200 of an exemplary implementation of a multiple user display. The screenshot 200 illustrates a grid 204 including a plurality of calendar spaces. Each of the calendar spaces may store a calendar item, such as a first item 206A, a second item 206B, and a third item 206C (collectively referred to as items 206). The items 206 may be indicated by shading, as illustrated in FIG. 2, or other suitable graphical representation. Although not so illustrated in FIG. 2, it should be appreciated that each of the plurality of calendar items may include text describing the calendar item.

As illustrated in FIG. 2, each of the plurality of calendar items is scheduled for Feb. 22, 2007 as indicated at 208. Each of the plurality of calendar item corresponds to a time frame along a horizontal axis 210 and a group member along a vertical axis 212. The horizontal axis 210 shows a time span between 10 AM and 2:30 PM from which a time frame for each calendar item may be selected. The vertical axis 212 lists a number of group members, including a first member 214 named “Alice”, a second member 216 named “Bob”, and a third member 218 named “Charles”. The first item 206A, the second item 206B, and the third item 206C are each scheduled between 10 AM and 11 AM. The first item 206A is associated to the first member 214. The second item 206B is associated with the second member 216, and the third item 206C is associated with the third member 218.

One drawback with a conventional multiple user display is that each individual member of a group is responsible for managing group membership as shown in the multiple user display. In particular, each user may be responsible for maintaining an accurate and current membership list as well as manually updating group members listed in the multiple user display. For example, if the third member 218 leaves the group, then each member of the group may be responsible for deleting the third member 218 from the vertical axis 114. If a fourth member 220 named “Debbie” decides to join the group, then each member of the group may be responsible for manually adding the fourth member 220 to the vertical axis 114. Shifting the responsibility to individual users to maintain a record of any changes to the group membership and to manually update the multiple user display to reflect the changes may be significantly burdensome to users.

Another drawback with a conventional multiple user display is its ability to only display a day calendar. For example, the screenshot 200 illustrates multiple calendars for only one day, Feb. 22, 2007. Conventional multiple user displays are not capable of providing multiple calendars for longer time spans, such as a week. For example, the configuration of the multiple user display as illustrated in FIG. 2 is not easily scaled for any time span greater than a day because only a limited number of hours can be simultaneously displayed.

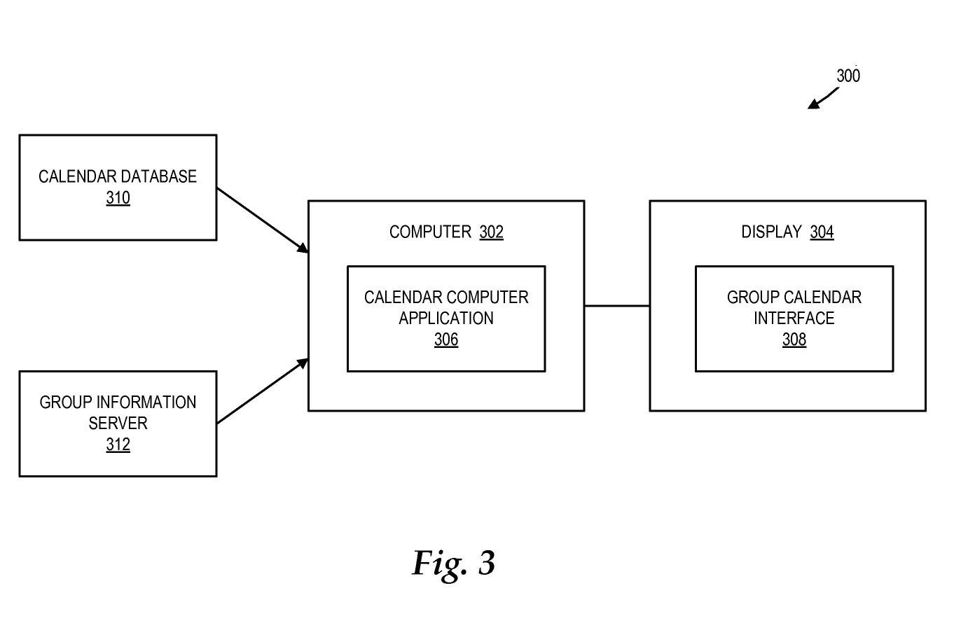

Referring now to FIG. 3, aspects of a computing system and methodology for providing an improved group schedule will be described. In particular, FIG. 3 illustrates a simplified computer system 300 for providing an improved group calendar. The computer system 300 includes a computer 302 and a display 304 operatively coupled to the computer 302. The computer 302 may be any standard processor-based system including, but not limited to, a desktop computer, a laptop computer, a personal digital assistant (“PDA”), a smartphone, and the like. The display 304 may be any suitable device, such as a computer monitor, capable of displaying output from the computer 302.

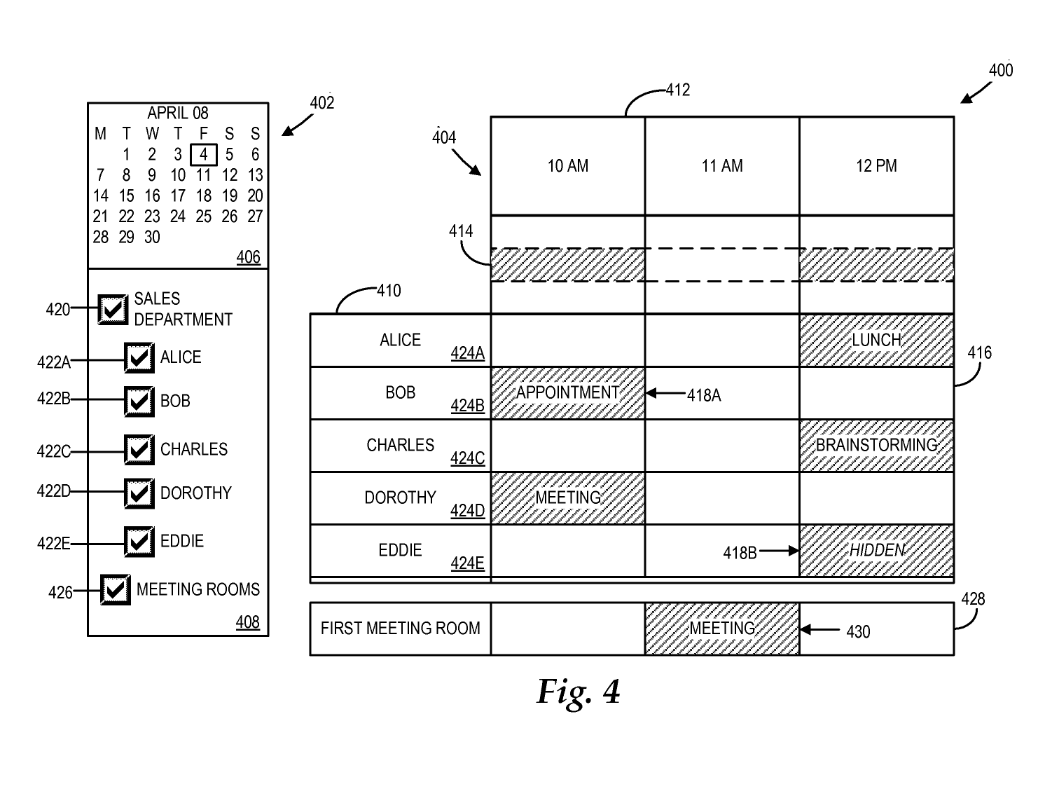

As illustrated in FIG. 3, the computer 302 is adapted to execute a calendar computer application 306. Upon executing the calendar computer application 306, the computer 302 may display a group calendar interface 308 on a display 304. The group calendar interface 308 provides an improved group calendar as described herein. The group calendar interface 308 may be provided as a default feature of the calendar computer application 306. Alternatively, the group calendar interface 308 may be provided as an option within the calendar computer application 306. For example, the group calendar interface 308 may provide an option (e.g., a graphical button) to easily alternate between a conventional individual calendar display and the group calendar interface 308. The group calendar interface 308 is described in greater detail below with respect to FIG. 4.

The calendar computer application 306 is capable of accepting input from a calendar database 310 and a group information server 312 over any suitable network, such as a local area network (“LAN”) or the Internet. The calendar database 310 stores individual calendars entered by users via a suitable calendar computer application, such as the calendar computer application 306. Each individual calendar in the calendar database 310 may include a plurality of calendar items, each of which is associated with a designated date and time for an appointment, meeting, or other event. The calendar items may include any relevant information related to the event, such as the location of the event and a list of other users attending the event.

The group information server 312 may be any suitable server adapted to store information that may be used to generate groups. The group information server 312 may be a server that is centrally updated across an enterprise. In this way, individual users operating the calendar computer application 306 are not required to manually update group membership. In one embodiment, the group information server 312 is an email server. Examples of email servers include, but are not limited to, EXCHANGE from MICROSOFT CORPORATION, GROUPWISE from NOVELL INC., and LOTUS DOMINO from INTERNATIONAL BUSINESS MACHINES CORPORATION. Many enterprise email servers categorize users into different groups. For example, many enterprise address books enable users to create groups of multiple users to facilitate group emails. It should be appreciated that other types of services and computer applications that group users into categories may be similarly utilized. Group membership may be based on department (e.g., sales, finance, marketing, human resources), employee title (e.g., manager, supervisor, senior associate, contractor), location, or other suitable category. In this way, users can easily view members by group and email an entire group without having to add every individual member of the group to the email. In one embodiment, the calendar computer application 306 is adapted to utilize group information available on the email server to categorize users into groups for the purposes of scheduling calendar items for one or more group members.

In an illustrative example, an exemplary email server categorizes a company's employees based on department, such a sales department. The sales department includes five employees: Alice, Bob, Charles, Dorothy, and Eddie. If an employee of the company wants to send an email to every member of the sales department, the employee may simply enter “Sales Department” in the “To” field as opposed to manually adding individual email addresses corresponding to Alice, Bob, Charles, Dorothy, and Eddie. The email server is adapted to insert the individual email addresses corresponding to every member of the sales department. In one embodiment, the calendar computer application 306 is adapted to retrieve (i.e., in a “pull” model) or receive (i.e., in a “push” model) the current group membership for the sales department.

Upon retrieving or receiving the group membership for the sales department, the calendar computer application 306 may create groups corresponding to the user accessing the calendar computer application 306 based on the group membership. For example, when Alice accesses the calendar computer application 306, the calendar computer application 306 may create a sales department group because Alice is an employee in the sales department, and then populate the sales department group with Alice, Bob, Charles, Dorothy, and Eddie.

In another embodiment, groups may be created based on other suitable information provided by the group information server 312. In one example, groups may be created based on a number of emails and/or a frequency of emails transmitted to and received from particular users. The group information server 312 may contain information indicating that Alice frequently emails Bob and Charles. Accordingly, when Alice accesses the calendar computer application 306, the calendar computer application 306 may create a group that includes Alice, Bob, and Charles. In yet another embodiment, groups may be created based on information stored locally on the computer 302 without accessing the group information server 312.

Referring now to FIG. 4, aspects of a group calendar interface, such as the group calendar interface 308, capable of providing an improved group calendar will be described. In particular, FIG. 4 illustrates a screenshot 400 of an exemplary implementation of the group calendar interface 308. The screenshot 400 illustrates a menu portion 402 and a calendar portion 404. The menu portion 402 includes a day selector 406 and a group list 408. The calendar portion 404 includes a a member list 410, a time list 412, a group status indicator 414, and a calendar grid 416. The menu portion 402 enables a user to customize the information displayed in the calendar portion 404. In particular, the day selector 406 enables a user to select a month and day of calendar items, such as a first item 418A and a second item 418B, displayed in the calendar grid 416. The calendar grid 416 includes a plurality of calendar spaces, each of which is capable of storing a calendar item. As illustrated in FIG. 4, the user has selected April 4, 2008. As such, the calendar items, such as the first item 418A and the second item 418B, displayed in the calendar grid 416 are scheduled for Apr. 4, 2008.

The group list 408 displays one or more groups associated with the user accessing the group calendar interface 308. For each of the groups, the associated group members are also listed. As illustrated in FIG. 4, a sales department group 420 is shown. The sales department group 420 includes five members: a first member 422A named “Alice”, a second member 422B named “Bob”, a third member 422C named “Charles”, a fourth member 422D named “Dorothy”, and a fifth member 422E named “Eddie” (collectively referred to as members 422). A number of checkboxes are displayed next to sales department group 420 and each of the members 422. The checkboxes enable enables a user to select the sales department group 420 and one or more of the members 422. As illustrated in FIG. 4, a user has selected the sales department group 420. By selecting the department group 420, the user selects all of the members 422. Alternatively, the user may select individual members by selecting the corresponding checkboxes.

The members selected in the group list 408 are displayed in the member list 410. For example, a user has selected the all of the members 422 by selecting the sales department group 420 in the group list 408. As such, the member list 410 includes a first member 424A, a second member 424B, a third member 424C, a fourth member 424D, and a fifth member 424E (collectively referred to as members 424). The first member 424A, the second member 424B, the third member 424C, the fourth member 424D, and the fifth member 424E correspond to the first member 422A, the second member 422B, the third member 422C, the fourth member 422D, and the fifth member 422E, respectively.

The member list 410 forms the vertical axis for the calendar grid 416. The time list 412 forms the horizontal axis for the calendar grid 416. The time list 412 may display any suitable time span. As illustrated in FIG. 4, the time list 412 displays a time span between 10 AM and 1 PM. In other embodiments, the time list 412 may include any suitable time span. The time span may also be customizable by a user. In an illustrative example, the time list 412 may include a time span between 8 AM and 6 PM, which is a common workday for many people. Each of the plurality of calendar items, such as the first item 418A and the second item 418B, correspond to one of the members 424 and a time frame selected from the time list 412. For example, the first item 418A corresponds to the second member 424B and a time frame between 10 AM and 11 AM. Although not so illustrated in FIG. 4, it should be appreciated that the menu portion 402 may include scrolling functionality whereby a user can scroll horizontally to view additional times and/or vertically to view additional members.

Each of the plurality of calendar items, such as the first item 418A and the second item 418B, is indicated by shading, as illustrated in FIG. 4. In other embodiments, the calendar items may be indicated by other suitable graphical representation. Further, each of the plurality of calendar items may include text describing the calendar item. In one embodiment, the information displayed in a calendar item may be hidden by the user. For example, as illustrated in FIG. 4, the fifth member 424E has blocked access to at least a portion of his calendar. As such, while a user can see from the shading of the second item 418B that that the fifth user 424E is busy in the time frame between 12 PM and 1 PM, the user is blocked from viewing any information on the event that the fifth user 424E has scheduled at that time.

By positioning the calendar items associated with multiple group members in an orientation as illustrated in FIG. 4, it becomes easier for a user to visually determine when one or more members group are available. In particular, the user only needs to look for empty columns on the calendar grid 416. For example, as illustrated in FIG. 4, the members 424 have no scheduled calendar items between 11 AM and 12 PM. To further aid in the visual indication that all of the members 424 are available between 11 AM and 12 PM, the group status indicator 414 is shaded in the time frame between 10 AM and 11 AM and between 12 PM and 1 PM to indicate that at least one of the members 424 is busy during those times. In this way, a user can quickly determine when all of the members 424 are available for scheduling a collaborative event by looking for a non-shaded time frame. In one embodiment, a user may select one or more of the empty calendar spaces to schedule a collaborative event for one or more of the members 424. In this way, a user can schedule a group event without needing to schedule the event for each group member individually. The user can also schedule a group event for only a subset of the members 424, as opposed to all of the members 424. In another embodiment, a user may select the group status indicator 414 at a non-shaded area, such as the time frame between 11 AM and 12 PM, to schedule a collaborative event for all of the members 424.

Although not so illustrated in FIG. 4, the group calendar interface 308 may also include an interface for searching an available time frame in which all of the members 424 are available. For example, the group calendar interface 308 may include a “Go to Next Available Time” button and a “Go to Previous Available Time” button. By selecting the “Go to Next Available Time” button, the user can access a time frame after a given time when all of the members 424 are available. By selecting the “Go to Previous Available Time” button, the user can access a time frame before a given time when all of the members 424 are available.

In one embodiment, the calendar portion 404 is adapted to show not only the availability of the members 424, but also to show the availability of suitable resources. The availability of resources may be determined based on information provided by the group information server 312 or the computer 302. In an illustrative example, a meeting rooms group 426 is selected in the group list 408. Once the meeting rooms group 426 is selected, the calendar portion 404 displays schedules for one or more meeting rooms. As illustrated in FIG. 4, the schedule for a first meeting room is displayed in a meeting room schedule 428. It should be appreciated that multiple meeting rooms may be shown. An item 430 is shaded to indicate that the first meeting room is reserved between 11 AM to 12 PM for a meeting.

It should be noted that, in accordance with one embodiment, the group status indicator 414 is not shaded between 11 AM to 12 PM even though the item 430 is shaded to indicate that the first meeting room is reserved during that time frame. In this case, the group status indicator 414 indicates only the availability of the members 424, and does not indicate the availability of the first meeting room and other resources. In other embodiments, the group status indicator 414 may also indicate the availability of resources.

In one embodiment, when an event is scheduled, the event is automatically scheduled in a meeting room that is available during the scheduled time frame. For example, if one of the members 424 schedules a meeting in the time frame between 11 AM and 12 PM, the calendar computer application 306 may select a meeting room other than the first meeting room since the first meeting room is reserved during that time frame.

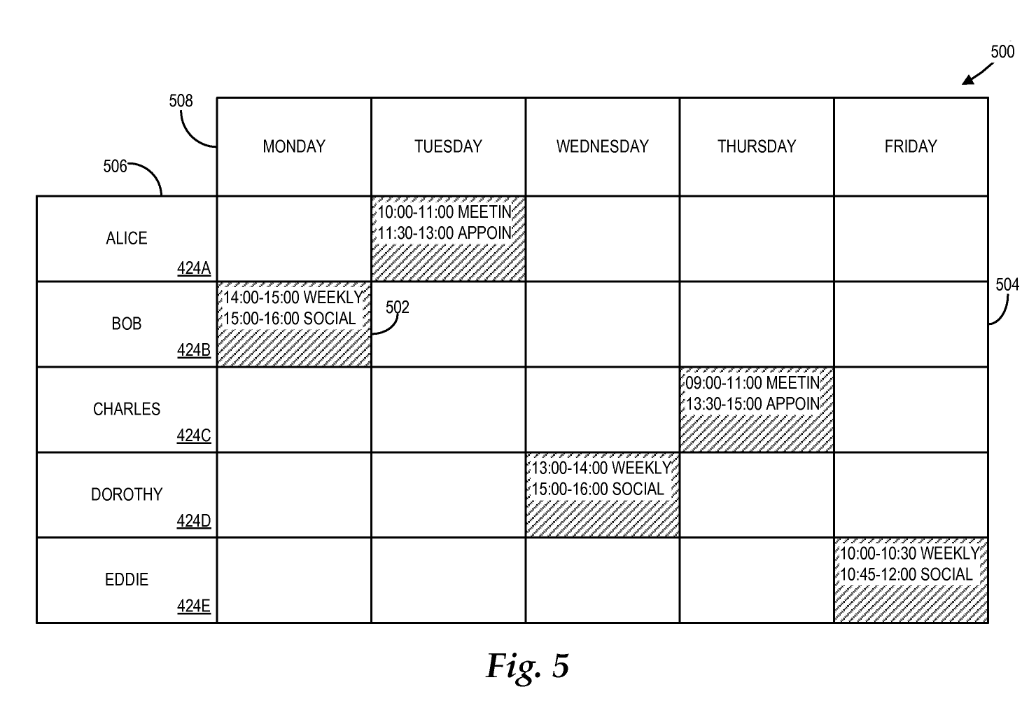

Referring now to FIG. 5, another implementation of the calendar portion 404 illustrated in FIG. 4 will be described. In particular, FIG. 5 illustrates a calendar portion 500 for simultaneously displaying multiple calendars associated with multiple group members. Unlike the calendar portion 404 that provides a daily view of calendar items, the calendar portion 500 provides a weekly view of calendar items, such as a calendar item 502, in a calendar grid 504. Each of the plurality of calendar items is associated with one of the members 424 listed along a vertical axis 506 and one of the days listed along a horizontal axis 508. For example, the calendar item 502 is associated with the second member 424B and is scheduled on a Tuesday.

As illustrated in FIG. 5, each of the calendar spaces in the calendar grid 504 includes sufficient space to display text corresponding to each of the events scheduled for each day. Although not so illustrated in FIG. 4, it should be appreciated that each of the calendar spaces may include scrolling functionality whereby a user can scroll horizontally and/or vertically to view additional text and events.

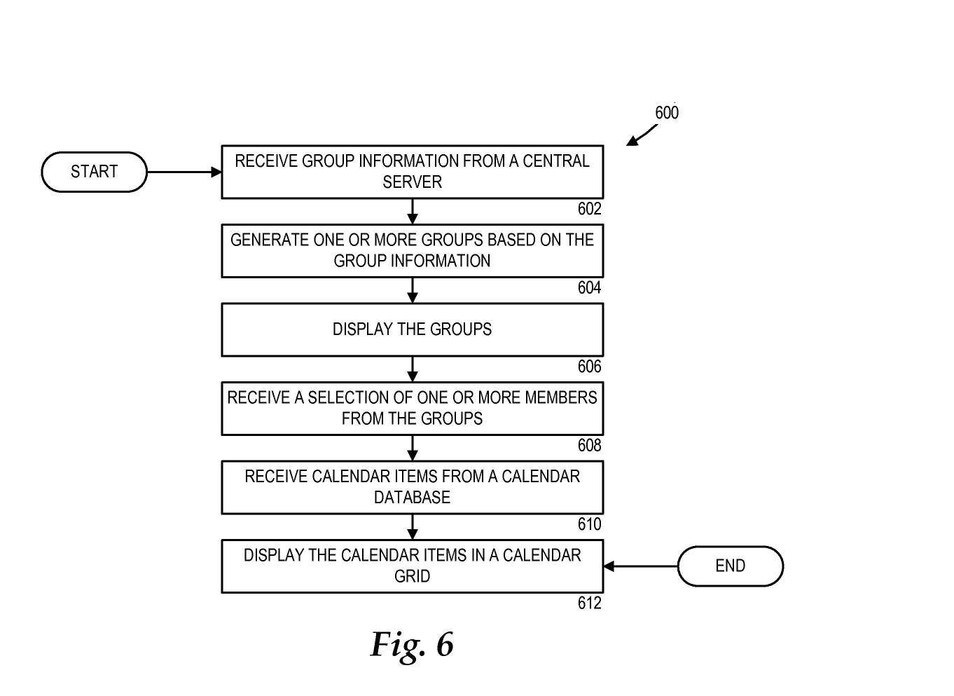

Turning now to FIG. 6, additional details will be provided regarding the calendar computer application 306 and the group calendar interface 308. In particular, FIG. 6 is a flow diagram illustrating aspects of one method provided herein for providing the group calendar interface 308. It should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof. It should be appreciated that more or fewer operations may be performed than shown in the figures and described herein. These operations may also be performed in a different order than those described herein.

Referring to FIG. 6, a routine 600 begins at operation 602, where the calendar computer application 306 receives or retrieves group information from a central server, such as the group information server 312. For example, the group information server 312 may be an email server or other suitable central server. If the group information server 312 is an email server, then the group information may be group information available on a central address book. The group information may also include information on the number of emails and/or frequency of emails transmitted to and received from certain users. Upon receiving or retrieving the group information from the central server, the routine 600 proceeds to operation 604.

At operation 604, the calendar computer application 306 generates one or more groups based on the group information. In one example, the group information may include a list of employees for every department in an enterprise. In this case, each of the groups may correspond to a department in the enterprise, and the groups may be populated with members corresponding to the employees of each department. In another example, the group information may include information detailing frequent emails between three people. In this case, a group may be formed and populated with the three people. Upon generating one or more groups based on the group information, the routine 600 proceeds to operation 606.

At operation 606, the calendar computer application 306 displays the groups in the group calendar interface 308. For example, the groups may be displayed in the group list 408 as illustrated in FIG. 4. A user viewing the groups may select one or more members from the groups. The user may select a group in order to select every member of the group, or the user may select individual group members. For example, by selecting the sales department group 420, the user selects all of the members 422 corresponding to the sales department group 420. Upon displaying the groups, the routine 600 proceeds to operation 608.

At operation 608, calendar computer application 306 receives a selection of one or more members via the group calendar interface 308. The routine 600 proceeds to operation 610, where the group calendar interface 308 receives or retrieves calendar information for each of the selected members from the calendar database 310. The routine 600 proceeds to operation 612, where the calendar information is displayed on a calendar grid, such as the calendar grid 416.

In one embodiment, the calendar grid 416 includes a plurality of calendar spaces. One or more of the calendar spaces may store calendar items, each of which is associated with one member and is scheduled for a given time frame. The calendar grid 416 may also provide functionality whereby a user can schedule an event for multiple members at one time by selecting a plurality of calendar spaces.

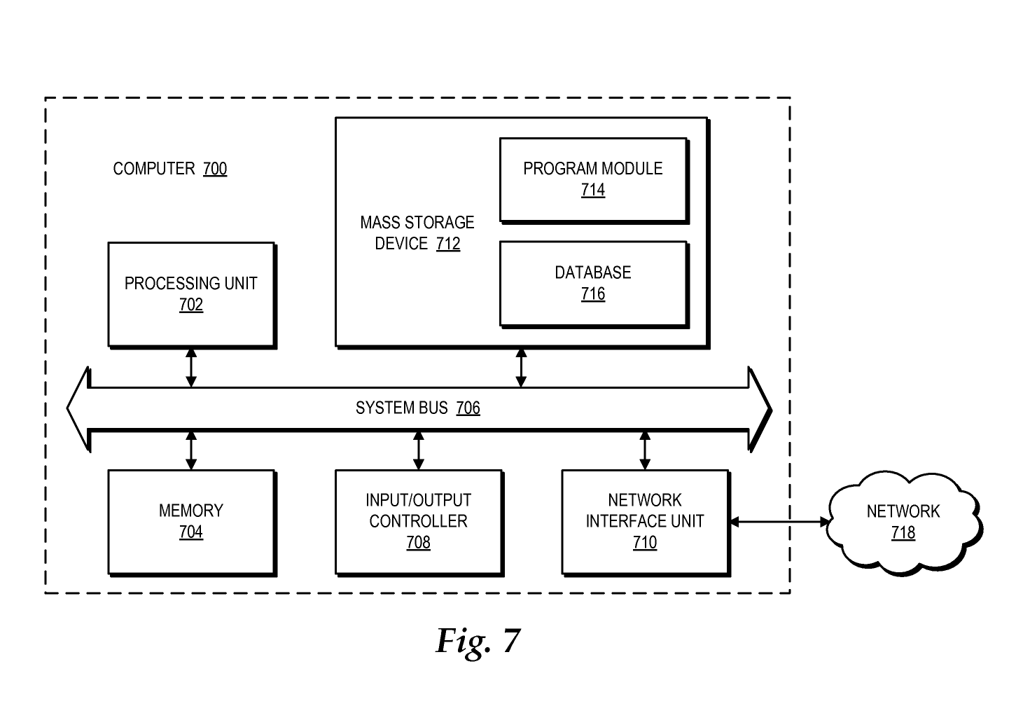

Referring now to FIG. 7, an exemplary computer architecture diagram showing aspects of a computer 700 is illustrated. Examples of the computer 700 may include computer 302 and the group information server 312. The computer 700 includes a processing unit 702 (“CPU”), a system memory 704, and a system bus 706 that couples the memory 704 to the CPU 702. The computer 700 further includes a mass storage device 712 for storing one or more program modules 714 and one or more databases 716. An example of the program modules 714 may include the calendar computer application 306. An example of the databases 716 may include the calendar database 310. The mass storage device 712 is connected to the CPU 702 through a mass storage controller (not shown) connected to the bus 706. The mass storage device 712 and its associated computer-readable media provide non-volatile storage for the computer 700. Although the description of computer-readable media contained herein refers to a mass storage device, such as a hard disk or CD-ROM drive, it should be appreciated by those skilled in the art that computer-readable media can be any available computer storage media that can be accessed by the computer 700.

By way of example, and not limitation, computer-readable media may include volatile and non-volatile, removable and non-removable media implemented in any method or technology for storage of information such as computer-readable instructions, data structures, program modules, or other data. For example, computer-readable media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer 700.

According to various embodiments, the computer 700 may operate in a networked environment using logical connections to remote computers through a network 718. The computer 700 may connect to the network 718 through a network interface unit 710 connected to the bus 706. It should be appreciated that the network interface unit 710 may also be utilized to connect to other types of networks and remote computer systems. The computer 700 may also include an input/output controller 708 for receiving and processing input from a number of input devices (not shown), including a keyboard, a mouse, a microphone, and a game controller. Similarly, the input/output controller 708 may provide output to a display or other type of output device (not shown).

Based on the foregoing, it should be appreciated that technologies for providing an improved group schedule are presented herein. Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A method for providing a group calendar interface, the method comprising:
receiving information from a central server;
generating a group based on the information; and
providing the group in the group calendar interface.

2. The method of claim 1, further comprising:
providing a selection interface in the group calendar interface for selecting a plurality of members from the group;
receiving a selection of the plurality of members; and
upon receiving the selection of the plurality of members, displaying calendar items associated with the plurality of members.

3. The method of claim 2, wherein displaying calendar items associated with the plurality of members comprises displaying calendar items associated with the plurality of members in a day view.

4. The method of claim 2, wherein displaying calendar items associated with the plurality of members comprises displaying calendar items associated with the plurality of members in a week view.

5. The method of claim 2, the method further comprising providing a scheduling interface for scheduling an event for the plurality of members at one time.

6. The method of claim 1, wherein the central server comprises an email server.

7. The method of claim 6, wherein generating a group based on the information comprises generating the group based on an address book provided by the email server.

8. The method of claim 6, wherein generating a group based on the information comprises generating the group based on emails received and transmitted.

9. A method for providing a group calendar interface, the method comprising:
providing along a first axis a plurality of members of a group, the plurality of members of the group being selected based on information provided by a central server;
providing along a second axis a time span; and
providing a calendar grid comprising a plurality of calendar entries, each of the calendar entries for storing a calendar item corresponding to one of the plurality of members along the first axis and a time frame selected from the time span along the second axis.

10. The method of claim 9, wherein the first axis is a vertical axis and the second axis is a horizontal axis.

11. The method of claim 9, wherein the time span is a daily time span.

12. The method of claim 9, wherein the time span is a weekly time span.

13. The method of claim 9, the method further comprising a group selection interface for selecting the plurality of members along the first axis.

14. The method of claim 9, the method further comprising providing a group status indicator for indicating whether the time frame is available for the plurality of members of the group.

15. The method of claim 9, the method further comprising a scheduling interface for scheduling an event for the plurality of members of the group at one time.

16. The method of claim 9, wherein the calendar grid displays text for each of the plurality of calendar items, the text comprising a description of the calendar items.

17. The method of claim 16, wherein the text is hidden from view in the calendar grid as specified by the one of the plurality of members.

18. A computer-readable medium having computer-executable instructions stored thereon which, when executed by a computer, cause the computer to:
receive group information from an email server;
generate a group based on the group information;
display the group in a group calendar interface;
receive a selection of a plurality of members from the group via the group calendar interface;
upon receiving the selection of the plurality of members, retrieve calendar items corresponding to the plurality of members from a calendar database; and
display in the group calendar interface a calendar grid comprising a plurality of calendar items, each of the plurality of calendar items being associated with one of the plurality of members displayed along a first axis of the calendar grid and a time frame displayed along a second axis of the calendar grid.

19. The computer-readable medium of claim 18, wherein the group information comprises groups specified by an address book stored on the email server.

20. The computer-readable medium of claim 18, wherein the group information comprises a number of emails received and transmitted between the plurality of members.
